(19) United States
(12) Patent Application Publication
(10) Pub. No.: US 2022/0164525 A1
(43) Pub. Date: May 26, 2022

(54) INFORMATION PROCESSING APPARATUS, CONTROL METHOD FOR SAME, AND STORAGE MEDIUM

(71) Applicant: CANON KABUSHIKI KAISHA, Tokyo (JP)

(72) Inventor: Yuya Owari, Tokyo (JP)

(21) Appl. No.: 17/669,166

(22) Filed: Feb. 10, 2022

Related U.S. Application Data
(63) Continuation of application No. PCT/JP2020/029183, filed on Jul. 30, 2020.

(30) Foreign Application Priority Data
Aug. 27, 2019 (JP) 2019-154618

(51) Int. Cl. G06F 40/177

(52) U.S. Cl. CPC G06F 40/177

(57) ABSTRACT

Conventionally, in a case where a plurality of pieces of tag information automatically provided with respect a content is arranged and displayed in random order, there is an issue where an at-a-glance view of the tag information is degraded. The present invention is directed to an information processing apparatus by which first related information with respect to a content is determined and a plurality of pieces of second related information with respect to the content is acquired. Then, the order of the plurality of pieces of second related information is set based on the first related information, and a screen information is generated such that the plurality of pieces of second related information is arranged and displayed on a screen according to the set order.

### CROSS-REFERENCE TO RELATED APPLICATIONS

This application is a Continuation of International Patent Application No PCT/JP2020/029183, filed Jul. 30, 2020, which claims the benefit of Japanese Patent Application No. 2019-154618, filed Aug. 27, 2019, both of which are hereby incorporated by reference herein in their entirety.

### BACKGROUND OF THE INVENTION

### Field of the Invention

The present invention relates to a technique for displaying a list of a plurality of pieces of related information with respect to a content.

### Background Art

Conventionally, an image is analyzed to automatically provide a plurality of pieces of tag information as information related to the image, and a list of the pieces of tag information is displayed (Patent Document 1).

### CITATION LIST

### Patent Literature

PTL 1: Japanese Patent Laid-Open No. 2013-235457

### SUMMARY OF THE INVENTION

In a case where a plurality of pieces of tag information is automatically provided with respect to an image, and a list of these pieces of tag information is displayed in random order, there is an issue where a user cannot easily ascertain which tag information has been provided or cannot easily find desired tag information due to a lack of certain criterion for the arrangement.

According to an aspect of the present invention, an information processing apparatus includes a determination unit configured to determine first related information with respect to a content, an acquisition unit configured to acquire a plurality of pieces of second related information with respect to the content, a setting unit configured to set order of the plurality of pieces of second related information based on the first related information, and a generation unit configured to generate screen information so that the plurality of pieces of second related information is arranged and displayed on a screen according to the set order.

According to the present invention, a plurality of pieces of tag information that has been automatically provided with respect to a content is arranged and displayed in accordance with a certain criterion based on a characteristic of the content, instead of random order. Thus, an effect is acquired in which an at-a-glance view of the tag information is enhanced.

Further features of the present invention will become apparent from the following description of exemplary embodiments with reference to the attached drawings.

### BRIEF DESCRIPTION OF THE DRAWINGS

FIG. 1 is a block diagram illustrating one example of a configuration of a content management system according to one exemplary embodiment of the present embodiment.

FIG. 2 is a block diagram illustrating one example of a configuration of a computer apparatus according to one exemplary embodiment of the present invention.

FIG. 3 is a flowchart illustrating one example of an operation performed by a first information processing apparatus 101 according to one exemplary embodiment of the present invention.

FIG. 4A is a diagram illustrating one example of a table indicating a score for a degree of relation between category information and tag information according to one exemplary embodiment of the present invention.

FIG. 4B is a diagram illustrating one example of a table indicating a score for degree of relation between category information and tag information according to one exemplary embodiment of the present invention.

FIG. 5 is a diagram illustrating one example of a content display screen according to one exemplary embodiment of the present invention.

### DESCRIPTION OF THE EMBODIMENTS

Hereinafter, a preferable exemplary embodiment of the invention is described in detail with reference to the drawings. However, components described in the exemplary embodiment are illustrative only, and the descriptions are not intended to limit the scope of the invention.

### First Exemplary Embodiment

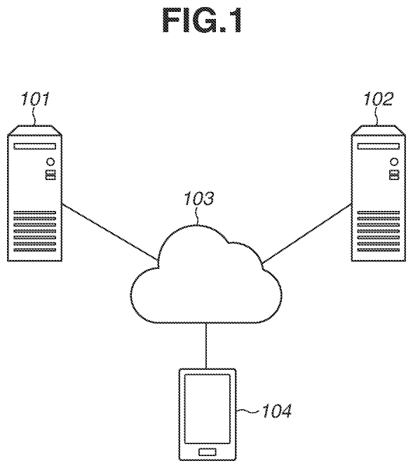

FIG. 1 is a block diagram illustrating one example of a configuration of a content management system according to the present invention.

A first information processing apparatus 101 and a second information processing apparatus 102 are implemented by a server computer apparatus. An electronic apparatus 104 is implemented by a computer apparatus such as a personal computer or a smart phone. The first information processing apparatus 101 is communicable with each of the second information processing apparatus 102 and the electronic apparatus 104 via a network 103.

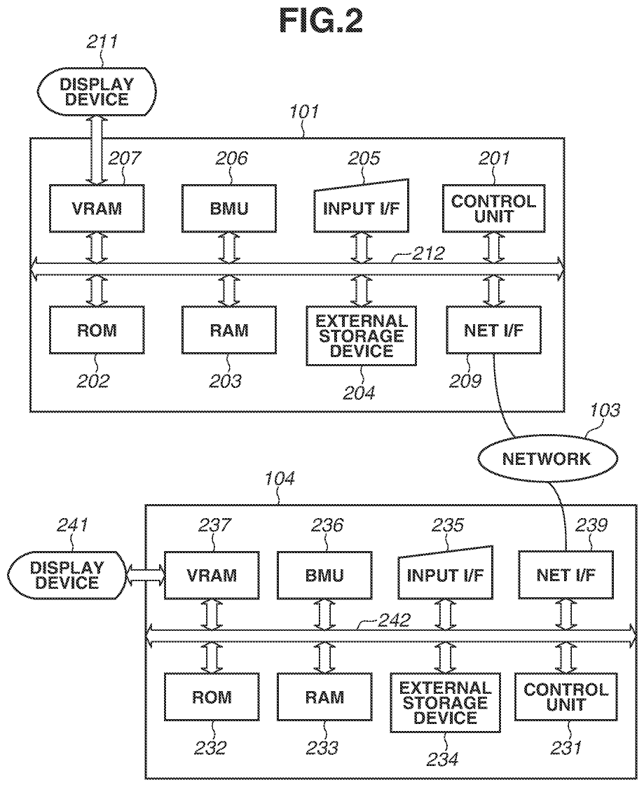

FIG. 2 is a block diagram illustrating one example of a configuration of a computer apparatus each including the first information processing apparatus 101 and the electronic apparatus 104. Each of the first information processing apparatus 101 and the electronic apparatus 104 may be implemented by a single computer apparatus. Alternatively, functions of the first information processing apparatus 101 and the electronic apparatus 104 may be distributed to a plurality of computer apparatuses as needed so that the first information processing apparatus 101 and the electronic apparatus 104 may be implemented by the plurality of computer apparatuses. In a case where a plurality of computer apparatuses is provided, the plurality of computer apparatuses is connected by, for example, a local area network (LAN) so as to be communicable with each other.

In FIG. 2, a control unit 201 comprehensively controls the first information processing apparatus 101, and a control unit 231 comprehensively controls the electronic apparatus 104. The control units 201 and 231 are, for example, central processing units (CPUs). Read only memories (ROMs) 202 and 232 store programs and parameters that do not need to be changed. Random access memories (RAMS) 203 and 233 temporarily store programs and data that are supplied from devices such as external devices. External storage devices 201 and 234 are hard disk drives (HDDs) that are respectively disposed in the first information processing apparatus 101 and the electronic apparatus 104 in a fixed manner. Alternatively, each of the external storage devices 204 and 234 may be a solid state drive (SSD) including a flash memory, a hybrid drive with a combination of an HDD and a flash memory, or a memory card. Each of the external storage devices 204 and 234 stores a program such as an operating system (OS). Each of input interfaces 205 and 235 receives an operation from a user, and is connected to input devices, such as a pointing device and a keyboard, that are used to input data. Bit move units (BMUs) 206 and 236 control data transfer, for example, between memories (e.g., between a video random access memory (VRAM) 207 and another memory and between a VRAM 237 and another memory), and between memories and respective input output (I/O) devices (e.g., network interfaces 209 and 239). The VRAMs 207 and 237 render images to be displayed on respective display devices 211 and 241. The images generated in the VRAMs 207 and 237, respectively are transmitted to the display devices 211 and 241 based on a predetermined rule, so that the display devices 211 and 241 display the images. The network interfaces 209 and 239 are connected to a network 103 such as Internet. A system bus 212 causes each of the units 201 through 209 to be communicably connected, and a system bus 242 causes each of the units 231 through 239 to be communicably connected.

Each of the external storage devices 204 and 234 stores contents such as an image file and a music file.

Moreover, the second information processing apparatus 102 has a configuration similar to that of the first information processing apparatus 101.

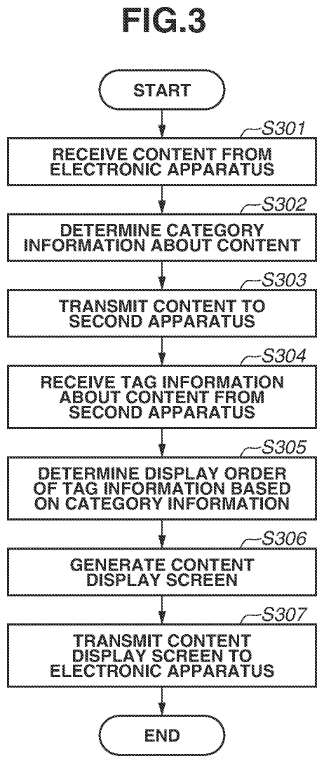

FIG. 3 is a flowchart illustrating one example of an operation performed by the first information processing apparatus 101 to generate display screen information so that a content, category information (first related information), and tag information (second related information) are displayed. on the electronic apparatus 104. The control unit 201 of the first information processing apparatus 101 implements the operation below by reading out a program such as an OS stored in the external storage device 204 to execute the program and controlling each unit.

In step S301, the control unit 201 receives a content from the electronic apparatus 104 via the network 103, and stores the received content in the external storage device 204. In step S302, the control unit 201 determines category information about the content based on a first learning model of machine learning.

Next, in step S303, the control unit 201 transmits the content to the second information processing apparatus 102 via the network 103. In step S304, the control unit 201 receives tag information about the content from the second information processing apparatus 102. Here, the second information processing apparatus 102 determines a plurality of pieces of tag information with respect to the content based on a second learning model of machine learning. The second learning model is generated by using input data and training data different from those for the first learning model and being adjusted with a parameter different from that for the first learning model. Thus, even if contents are the same, the tag information to be determined based on the second learning model includes information different from the category information to be determined based on the first learning model.

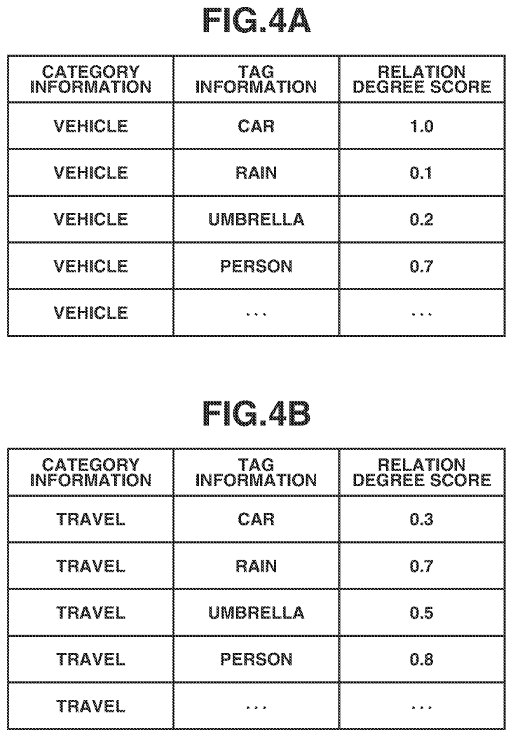

In step S305, the control unit 201 sets display order of the plurality of pieces of tag information received in step S304, based on the category information determined in step S302. Specifically, in the first information processing apparatus 101, a table as illustrated in FIGS. 4A and 4B is stored beforehand in the external storage device 204. The table indicates a score for a degree of relation to tag information for each piece of category information to be determined based on the first learning model. Since category information in FIG. 4A differs from that in FIG. 4B, relation degree scores in FIG. 4A differ from those in FIG. 4B in spite of the same tag information. In step S305, the control unit 201 reads out the table of the category information determined in step S302 from the external storage device 204 to acquire a relation degree score for each piece of tag information received in step S304, and sets display order of the tag information to the descending order of relation degree scores.

In step S306, the control unit 201 generates content display screen information so that the content, the category information determined in step S302, and the plurality of pieces of tag information received in step S304 are arranged and displayed according to the display order set in step S305. Then, the control unit 201 transmits the content display screen information to the electronic apparatus 104 via the network 103. The content display screen information may not include all of the plurality of pieces of tag information received in step S304. For example, a predetermined number of pieces of tag information having a higher degree of relation are displayed out of the plurality of pieces of tag information. Alternatively, tag information having a degree of relation that is greater than or equal to a threshold value is displayed.

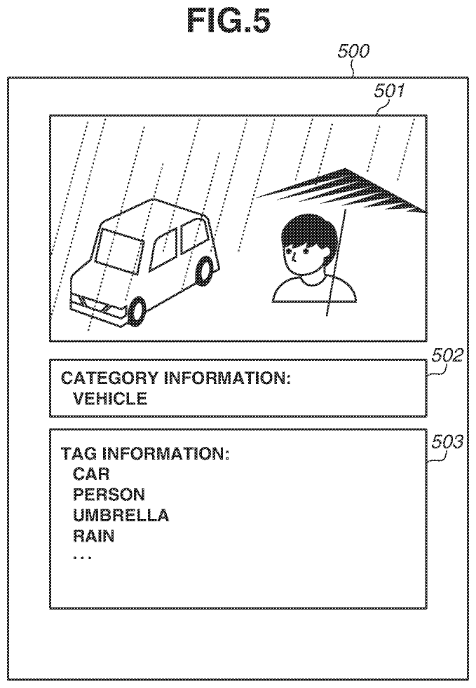

FIG. 5 is one example of a content display screen 500 to be displayed on the display device 241 of the electronic apparatus 104. The content received in the step S301 is displayed in a content display area 501. The category information determined in step S302 is displayed in a category display area 502. In a tag display area 503, the plurality of pieces of tag information received in step S304 is arranged and displayed according to the display order set in step S305.

In step S302, category information about the content may be determined without machine learning. For example, if a content is an image file, category information may be determined based on metadata such as an imaging time and an imaging location. Alternatively, a user may input optional category information.

If a content is a moving image file or a music file, tag information may be changed depending on a playback time. In such a case, in step S305, the display order may also he set based on appearance timing or appearance frequency.

Alternatively, in step 305, a score for a degree of relation between category information and tag information may be calculated each time the tag information is received instead of referring to the table retained beforehand. In such a case, for example, the score can be calculated using, for example, an algorithm that calculates a degree of language similarity.

Moreover, in step S304, the control unit 201 receives a degree of reliability of each of the plurality of pieces of tag information from the second information processing apparatus 102. However, the degree of reliability merely indicates a degree of estimated certainty of each piece of tag information based on a learning model of machine learning, and a user cannot ascertain a criterion thereof. Consequently, even in a case where a plurality of pieces of tag information is arranged and displayed based on a degree of reliability, it seems as if the plurality of pieces of tag information is arranged and displayed in random order to a user. In the present exemplary embodiment, a plurality of pieces of tag information is displayed in display order that is provided based on a content characteristic (content information) and differs from the order of degree of reliability. Thus, an at-a-glance view of the tag information is enhanced for a user.

The present exemplary embodiment has been described using a case in which each of the first information processing apparatus 101, the second information processing apparatus 102, and the electronic apparatus 104 is implemented as an independent apparatus. However, the present exemplary embodiment is not limited thereto. The present exemplary embodiment may be appropriately applied to a case in which the first information processing apparatus 101, the second information processing apparatus 102, and the electronic apparatus 104 are implemented as a single apparatus having respective functions thereof. For example, functions of the first information processing apparatus 101 and the second information processing apparatus 102 may be implemented by a single apparatus, functions of the first information processing apparatus 101 and the electronic apparatus 104 may be implemented by a single apparatus, or functions of the first information processing apparatus 102 and the electronic apparatus 104 may be implemented by a single apparatus. Alternatively, functions of the first information processing apparatus 101, the second information processing apparatus 102, and the electronic apparatus 104 may be implemented by a single apparatus.

In addition, the first information processing apparatus 101, the second information processing apparatus 102, and the electronic apparatus 104 may each be connected via a LAN or short-range wireless communication, instead of a public line such as the Internet.

The present invention is not limited to the above embodiments and various changes and modifications can be made within the spirit and scope of the present invention. Therefore, to apprise the public of the scope of the present invention, the following claims are made.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
a determination unit configured to determine first related information with respect to a content;
an acquisition unit configured to acquire a plurality of pieces of second related information with respect to the content;
a setting unit configured to set order of the plurality of pieces of second related information based on the first related information; and
a generation unit configured to generate screen information so that the plurality of pieces of second related information is arranged and displayed on a screen according to the set order.

2. The information processing apparatus according to claim 1, wherein each of the first related information and the second related information is based on a different learning model of machine learning.

3. The information processing apparatus according to claim 1, wherein the determination unit determines the first related information based on metadata of the content, and the acquisition unit acquires the second related information determined based on a learning model of machine learning.

4. The information processing apparatus according to claim 1,
wherein the determination unit determines the first related information based on an input from a user, and
wherein the acquisition unit acquires the second related information determined based on a learning model of machine learning.

5. The information processing apparatus according to claim 2, wherein the order to be set differs from order based on degrees of estimated certainty from the learning model of machine learning for the second related information.

6. The information processing apparatus according to claim 1, further comprising a storage unit configured to store degrees of relation to the plurality of pieces of second related information for each piece of the first related information,
wherein the setting unit sets the order based on levels of the degrees of relation.

7. The information processing apparatus according to claim 1, further comprising a calculation unit configured to calculate a degree of relation between the first related information and each of the plurality of pieces of second related information based on a predetermined algorithm,
wherein the setting unit sets the order based on levels of the degrees of relation.

8. The information processing apparatus according to claim 1, further comprising:
a receiving unit configured to receive the content from an external electronic apparatus; and
a transmission unit configured to transmit the screen information to the electronic apparatus.

9. The information processing apparatus according to claim 1, wherein the acquisition unit acquires the second related information from another external information processing apparatus.

10. A control method for an information processing apparatus, the method comprising:
determining first related information with respect to a content;
acquiring a plurality of pieces of second related information with respect to the content;
setting order of the plurality of pieces of second related information based on the first related information; and
generating screen information so that the plurality of pieces of second related information is arranged and displayed on a screen according to the set order.

11. A non-transitory computer-readable storage medium storing a program causing a computer to function as each unit of the information processing apparatus according to claim 1.

12. A non-transitory computer-readable storage medium storing a program that, when executed by a processor, cause the processor to perform operations comprising:
determining first related information with respect to a content;
acquiring a plurality of pieces of second related information with respect to the content;
setting order of the plurality of pieces of second related information based on the first related information; and
generating screen information so that the plurality of pieces of second related information is arranged and displayed on a screen according to the set order.
